(19) United States
(12) Patent Application Publication
(10) Pub. No.: US 2025/0310689 A1
(43) Pub. Date: Oct. 2, 2025

(54) SIMULTANEOUS AUDIO OUTPUT RESULTING FROM PRIORITY ARBITRATION

(71) Applicant: TOYOTA JIDOSHA KABUSHIKI KAISHA, Aichi-ken (JP)

(72) Inventors: Toshiyuki AGA, Ota-ku (JP); Hideto KIMURA, Kobe-shi (JP)

(21) Appl. No.: 18/624,115

(22) Filed: Apr. 2, 2024

(51) Int. Cl. H04R 3/12; G06F 3/16; H04R 5/02; H04S 1/00

(52) U.S. Cl. CPC H04R 3/12; G06F 3/165; H04R 5/02; H04S 1/007; H04R 2499/13

(57) ABSTRACT

Simultaneous audio output resulting from priority arbitration is performed by receiving, while a front speaker and a rear speaker in communication with an amplifier output audio from a first application, a request to output audio from a second application, retrieving, for each of the first application and the second application, information representing a resource requirement, determining whether a head unit and an amplifier have sufficient resources to meet the resource requirement of each application for simultaneous audio output, instructing, in response to determining that the head unit and the amplifier have sufficient resources for simultaneous audio output, the amplifier to modify a first channel to remove one of a front speaker input or a rear speaker input, instructing the amplifier to associate a second channel with the second application for output to the one of the front speaker input or the rear speaker input that was removed from the first channel, and instructing the second application to activate audio transmission.

### BACKGROUND

An audio output device installed in a vehicle, such as a speaker or speaker system, is used by a plurality of applications. Some applications are non-flutter applications, which produce constant audio streams from radio, prerecorded physical media, internet, etc. Some applications are flutter applications, which produce intermittent audio data for navigation, warnings, etc. At any given time, more than one application may transmit requests for output by an audio output device or a video output device, such as a touch screen.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram for simultaneous audio output resulting from priority arbitration, according to at least some embodiments of the subject disclosure.

FIG. 2 is an informational flow for simultaneous audio output resulting from priority arbitration, according to at least some embodiments of the subject disclosure.

FIG. 3 is an operational flow for simultaneous audio output resulting from priority arbitration, according to at least some embodiments of the subject disclosure.

FIG. 4 is an operational flow for retrieving simultaneous audio output requirement information and determining whether the requirements are met, according to at least some embodiments of the subject disclosure.

FIG. 5 is an operational flow for implementing simultaneous audio output, according to at least some embodiments of the subject disclosure.

FIG. 6 is a block diagram of a hardware configuration for simultaneous audio output resulting from priority arbitration, according to at least some embodiments of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In some vehicles known to the inventors, output devices are limited, and therefore requests by applications to output to an output device are handled via mediation rules. In such vehicles, an arbitration manager judges priority between applications based on the mediation rules stored in a mediation library, regarding screen output, basic sound output, and interrupt sound output, and resolves conflicts between applications. The arbitration manager transmits the judgement result to each application via an application manager.

In at least some embodiments described herein, instead of simply selecting one of the applications to utilize all output devices, an application manager determines whether simultaneous output is possible, and in response to determining that conditions allow for simultaneous output, the application manager enables audio transmission of one application to the front speakers of a vehicle simultaneously with audio transmission of another application to the rear speakers of the vehicle.

Although some vehicles support output of different audio streams simultaneously between front and rear speakers, such as RSE (Rear Seat Entertainment) compliant vehicle models, not every combination of audio streams will meet conditions for simultaneous play. For example, constraints of internal computational resources limit a head unit's capacity for decoding multiple audio streams. Also, certain applications require use of a head unit interface, such as smartphone applications, but some head unit interfaces do not support two application interfaces.

In at least some embodiments, an application manager or an arbitration manager is configured to check the specifications of any vehicle equipment used for audio, such as available resources and capabilities of a head unit, an amplifier, speakers, and any other in-vehicle equipment. In at least some embodiments, an application manager or an arbitration manager is configured to determine which application transmits audio, such as basic audio, interrupt audio, emergency call audio, etc., through which speaker in the vehicle in response to any changes to the vehicle's audio playback status.

In at least some embodiments, an application transmits a request for audio arbitration to an interface provided by the application manager or arbitration manager in response to generating audio data, and performs audio playback according to an arbitration result determined by the application manager or arbitration manager. In at least some embodiments, the audio arbitration enables applications to play audio without consideration of specifications of any vehicle equipment used for audio.

In at least some embodiments, audio arbitration begins while a head unit has already set an amplifier for output of audio from a first audio producing application to all speakers. In at least some embodiments, audio arbitration is triggered when the head unit receives a request to output audio from a second audio producing application. In at least some embodiments, the head unit reads information from each application to determine whether simultaneous play is possible by checking, for example, whether there are sufficient display resources to provide interfaces for both applications, whether there are sufficient decoding resources, especially memory, to decode both audio streams, whether any privacy or security restrictions prevent simultaneous play, etc. In at least some embodiments, the head unit instructs the amplifier to modify a first channel to remove front speaker inputs or rear speaker inputs in response to determining that simultaneous play is possible. In at least some embodiments, the head unit then instructs the amplifier to reserve a second channel for the removed speaker inputs. In at least some embodiments, the head unit instructs the second application to activate audio transmission in response to reserving the second channel.

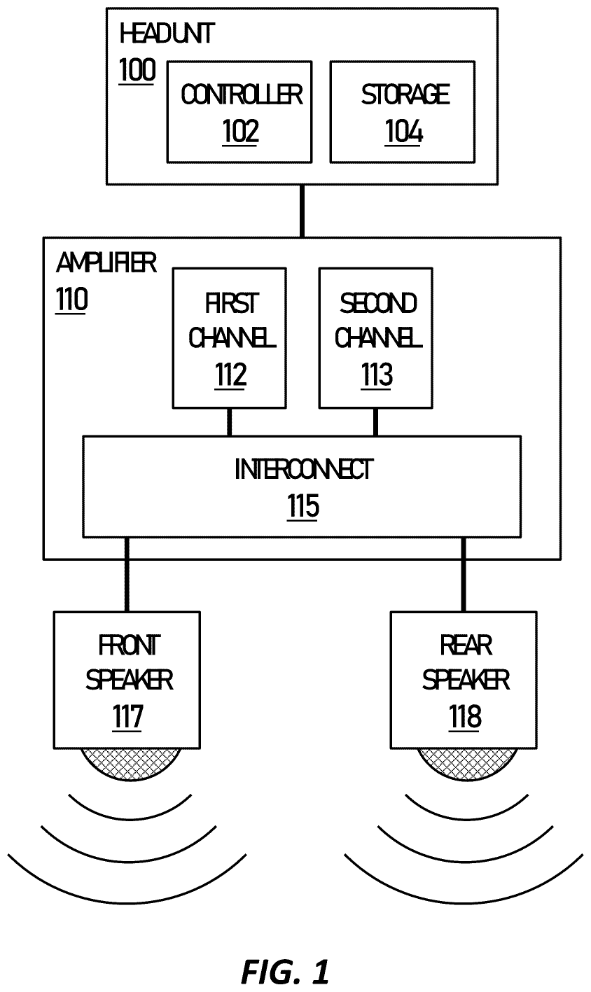

FIG. 1 is a schematic diagram of a system for simultaneous audio output resulting from priority arbitration, according to at least some embodiments of the subject disclosure. In at least some embodiments, the system is within an automobile or other vehicle. The schematic diagram includes a head unit 100, an amplifier 110, a front speaker 117, and a rear speaker 118.

Head unit 100 is connected to amplifier 110. Head unit 100 includes controller 102 and storage 104. In at least some embodiments, head unit 100 is configured to manage and control the operations of an audio system for the vehicle. In at least some embodiments, head unit 100 is a device that provides a user interface for the audio system. In at least some embodiments, head unit 100 includes a display, buttons, a touch screen, etc. In at least some embodiments, head unit 100 is for a car stereo system. In at least some embodiments, head unit 100 is configured to play media content.

Controller 102 is included in head unit 100. In at least some embodiments, controller 102 is configured to control the operations of head unit 100. In at least some embodiments, controller 102 is configured to manage the priority arbitration for simultaneous audio output. in at least some embodiments, controller 102 includes a microcontroller, microprocessor, or other logic applying circuitry. In at least some embodiments, controller 102 is configured to execute software instructions.

Storage 104 is included in head unit 100. In at least some embodiments, storage 104 is configured to store data. In at least some embodiments, storage 104 is configured to store information representing a resource requirement for each application. In at least some embodiments, storage 104 is configured to store user preference information. In at least some embodiments, storage 104 includes memory devices such as RAM, ROM, or flash memory. In at least some embodiments, storage 104 is a hard disk drive or solid-state drive. In at least some embodiments, storage 104 is configured to store programs, such as applications and operating systems that are executable by controller 102.

Amplifier 110 is connected to head unit 100. Amplifier 110 includes first channel 112, second channel 113, and interconnect 115. In at least some embodiments, amplifier 110 is configured to amplify audio signals. In at least some embodiments, amplifier 110 is configured to drive speakers. In at least some embodiments, amplifier 110 is configured to modify channels to add or remove speaker input. In at least some embodiments, amplifier 110 is configured to modify first channel 112 to remove one of a front speaker input or a rear speaker input. In at least some embodiments, amplifier 110 includes components such as transistors, capacitors, and resistors. In at least some embodiments, amplifier 110 is a standalone device. In at least some embodiments, amplifier 110 is integrated into head unit 100. In at least some embodiments, amplifier 110 includes a digital signal processor.

First channel 112 is included in amplifier 110 and is connected to interconnect 115. In at least some embodiments, first channel 112 is configured to relay audio signals. In at least some embodiments, first channel 112 is configured to be associated with a first application for output to a speaker. In at least some embodiments, first channel 112 includes circuitry for signal transmission. In at least some embodiments, first channel 112 is a software component, such as a computational resource reservation. In at least some embodiments, first channel 112 has at least one of an audio bitrate, sampling rate, buffer size, or equalizer setting corresponding to an application. In at least some embodiments, first channel 112 is configured to deliver audio content to a speaker, such as front speaker 117 or rear speaker 118.

Second channel 113 is included in amplifier 110 and is connected to interconnect 115. In at least some embodiments, second channel 113 is configured to relay audio signals. In at least some embodiments, second channel 113 is configured to be associated with a second application for output to a speaker. In at least some embodiments, second channel 113 includes circuitry for signal transmission. In at least some embodiments, second channel 113 is a software component, such as a computational resource reservation. In at least some embodiments, second channel 113 has at least one of an audio bitrate, sampling rate, buffer size, or equalizer setting corresponding to an application. In at least some embodiments, second channel 113 is configured to deliver audio content to a speaker, such as front speaker 117 or rear speaker 118.

Interconnect 115 is included in amplifier 110 and is connected to first channel 112, second channel 113, front speaker 117, and rear speaker 118. In at least some embodiments, interconnect 115 is configured to connect various channels and speakers of the audio system. In at least some embodiments, Interconnect 115 is configured to route audio signals between the channels and the speakers. In at least some embodiments, interconnect 115 includes wiring or other types of signal pathways. In at least some embodiments, interconnect 115 is a part of the internal circuitry of amplifier 110. In at least some embodiments, interconnect 115 is configured to facilitate signal transmission.

Front speaker 117 is connected to interconnect 115. In at least some embodiments, front speaker 117 is configured to output audio. In at least some embodiments, front speaker 117 is configured to output audio from a first application. In at least some embodiments, front speaker 117 includes components such as a diaphragm, a voice coil, and a magnet. In at least some embodiments, front speaker 117 includes at least one of a tweeter, a mid-range speaker, or a woofer. In at least some embodiments, front speaker 117 is configured to reproduce sound based on audio signals.

Rear speaker 118 is connected to interconnect 115. In at least some embodiments, rear speaker 118 is configured to output audio. In at least some embodiments, rear speaker 118 is configured to output audio from a second application. In at least some embodiments, rear speaker 118 includes components such as a diaphragm, a voice coil, and a magnet. In at least some embodiments, rear speaker 118 includes at least one of a tweeter, a mid-range speaker, or a woofer. In at least some embodiments, rear speaker 118 is configured to reproduce sound based on audio signals.

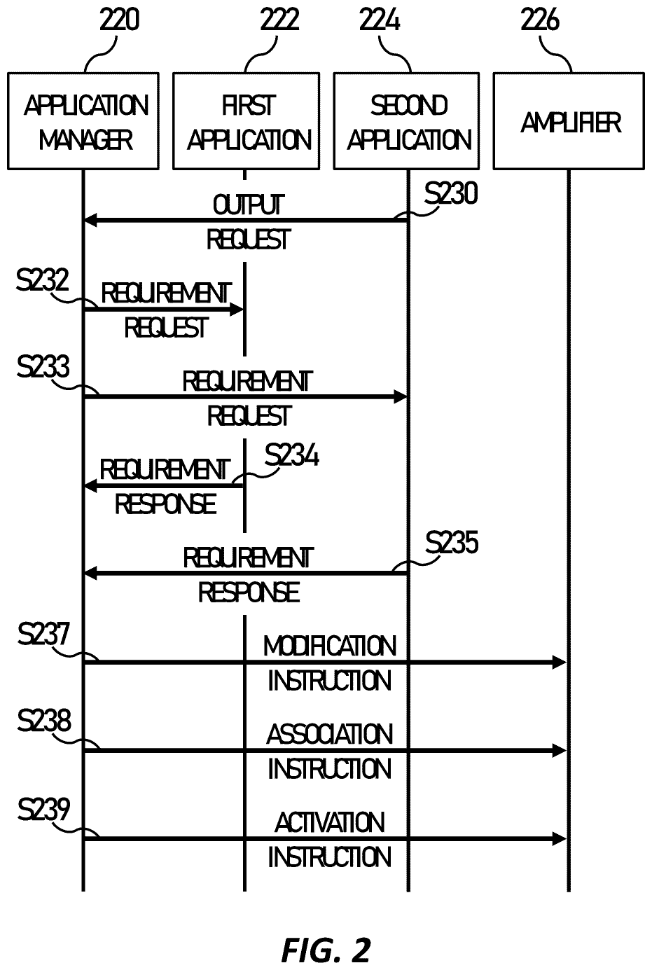

FIG. 2 is an informational flow for simultaneous audio output resulting from priority arbitration, according to at least some embodiments of the subject disclosure. The informational flow is among an application manager 220, a first application 222, a second application 224, and an amplifier 226. In at least some embodiments, information flows among applications through a network, such as an ethernet network, Controller Area Network (CAN), etc.

In at least some embodiments, application manager 220 is configured to manage multiple applications. In at least some embodiments, application manager 220 is configured to retrieve resource requirements from applications and instruct the amplifier based on the retrieved information. In at least some embodiments, application manager 220 includes software components that manage the execution of applications. In at least some embodiments, application manager 220 is a part of the operating system of a head unit, such as head unit 100 of FIG. 1. In at least some embodiments, application manager 220 resides in storage, such as storage 104 of FIG. 1, and is executed by a controller, such as controller 102 of FIG. 1. In at least some embodiments, application manager 220 is configured to mute or unmute audio output from speakers. In at least some embodiments, application manager 220 is configured to instruct amplifier 226 to associate channels with applications, modify audio output for switching between applications, etc. In at least some embodiments, application manager 220 is configured to manage the execution of applications and allocate resources.

In at least some embodiments, first application 222 is configured to provide audio output. In at least some embodiments, first application 222 is configured to output audio and provide resource requirement to application manager 220. In at least some embodiments, first application 222 includes software components that generate audio signals, process audio signals, and generate a user interface. In at least some embodiments, first application 222 resides in storage, such as storage 104 of FIG. 1, and is executed by a controller, such as controller 102 of FIG. 1. In at least some embodiments, first application 222 resides in and is executed by an ECU. In at least some embodiments, first application 222 resides in and is executed by a smartphone in wireless communication with the network. In at least some embodiments, first application 222 is a radio application, music streaming application, navigation application, emergency response application, etc. In at least some embodiments, first application 222 is a flutter or non-flutter application. In at least some embodiments, first application 222 is configured to play radio broadcasts or other audio content.

In at least some embodiments, second application 224 is configured to provide audio output. In at least some embodiments, second application 224 is configured to output audio upon receiving an activation instruction from application manager 220. In at least some embodiments, second application 224 includes software components that generate audio signals, process audio signals, and generate a user interface. In at least some embodiments, second application 222 resides in storage, such as storage 104 of FIG. 1, and is executed by a controller, such as controller 102 of FIG. 1. In at least some embodiments, second application 222 resides in and is executed by an ECU. In at least some embodiments, second application 222 resides in and is executed by a smartphone in wireless communication with the network. In at least some embodiments, second application 224 is a radio application, music streaming application, navigation application, emergency response application, etc. In at least some embodiments, first application 222 is a flutter or non-flutter application. In at least some embodiments, second application 224 is configured to play music or other audio content.

In at least some embodiments, amplifier 226 is configured to amplify audio signals. In at least some embodiments, amplifier 226 is configured to modify a channel and associate a channel with an application upon receiving instructions from application manager 220. In at least some embodiments, amplifier 226 includes hardware components that amplify audio signals. In at least some embodiments, amplifier 226 is a standalone device or integrated into a head unit, such as head unit 100 of FIG. 1. In at least some embodiments, amplifier 226 is configured to increase amplitude of an audio signal before transmitting the audio signal to a speaker. In at least some embodiments, amplifier 226 is configured to convert audio data received from a head unit to the audio signal before amplifying the audio signal. In at least some embodiments, amplifier 226 receives instructions and audio transmissions through a digital interface. In at least some embodiments, amplifier 226 is configured to drive speakers, such as front speaker 117 and rear speaker 118 of FIG. 1.

Prior to the informational flow of FIG. 2, application manager 220 has already associated a first channel of the amplifier to first application 224 for output to a front speaker input a rear speaker input.

At S230, second application 224 transmits an output request to application manager 220. In at least some embodiments, application manager 220 receives a request to output audio from a second application. In at least some embodiments, application manager 220 processes the output request to determine the necessary actions. In at least some embodiments, the output request is a signal or data packet. In at least some embodiments, the output request includes information about the type of audio to be output, such as audio bitrate, sampling rate, etc. In at least some embodiments, second application 224 transmits the output request in response to the second application receiving instruction to start outputting audio. In at least some embodiments, second application 224 transmits the output request in response to a user action, such as pressing a play button.

At S232, application manager 220 transmits a resource requirement request to first application 222. In at least some embodiments, application manager 220 retrieves information representing a resource requirement for each application. In at least some embodiments, first application 222 processes the resource requirement request to provide the necessary information. In at least some embodiments, the resource requirement request is a signal or data packet. In at least some embodiments, the resource requirement request includes a request for information about the resources required by first application 222. In at least some embodiments, the resource requirement request is made to determine if a head unit has sufficient resources for simultaneous audio output. In at least some embodiments, application manager 220 transmits the resource requirement request in response to receiving the audio output request from second application 224.

At S233, application manager 220 transmits a resource requirement request to second application 224. In at least some embodiments, second application 224 processes the resource requirement request to provide the necessary information. In at least some embodiments, the resource requirement request is a signal or data packet. In at least some embodiments, the resource requirement request includes a request for information about the resources required by second application 224. In at least some embodiments, the resource requirement request is made to determine if a head unit has sufficient resources for simultaneous audio output. In at least some embodiments, application manager 220 transmits the resource requirement request in response to receiving the audio output request from second application 224.

At S234, first application 222 transmits a resource requirement response to application manager 220. In at least some embodiments, application manager 220 receives the resource requirement response and uses it to determine whether the system has sufficient resources for simultaneous audio output. In at least some embodiments, the resource requirement response is a signal or data packet. In at least some embodiments, the resource requirement response includes information about the resources required by first application 222. In at least some embodiments, the resource requirement response is transmitted to inform application manager 220 about the resources required by first application 222. In at least some embodiments, first application 222 transmits the resource requirement response in response to receiving the resource requirement request from application manager 220.

At S235, second application 224 transmits a resource requirement response to application manager 220. In at least some embodiments, application manager 220 receives the resource requirement response and uses it to determine whether the system has sufficient resources for simultaneous audio output. In at least some embodiments, the resource requirement response is a signal or data packet. In at least some embodiments, the resource requirement response includes information about the resources required by second application 224. In at least some embodiments, the resource requirement response is transmitted to inform application manager 220 about the resources required by the second application. In at least some embodiments, second application 224 transmits the resource requirement response in response to receiving the resource requirement request from application manager 220.

At S237, application manager 220 transmits a modification instruction to amplifier 226. In at least some embodiments, application manager 220 instructs amplifier 226 to modify a first channel to remove one of a front speaker input or a rear speaker input. In at least some embodiments, amplifier 226 processes the modification instruction to modify the first channel accordingly. In at least some embodiments, the modification instruction is a signal or data packet. In at least some embodiments, the modification instruction includes information about how to modify the first channel. In at least some embodiments, application manager 220 transmits the modification instruction in response to determining that the head unit has sufficient resources for simultaneous audio output.

At S238, application manager 220 transmits an association instruction to amplifier 226. In at least some embodiments, application manager 220 instructs amplifier 226 to associate a second channel with second application 224 for output to the one of the front speaker input or the rear speaker input that was removed from the first channel. In at least some embodiments, amplifier 226 processes the association instruction to associate the second channel with second application 224. In at least some embodiments, the association instruction is a signal or data packet. In at least some embodiments, the association instruction includes information about how to associate the second channel with second application 224. In at least some embodiments, the association instruction is transmitted to enable second application 224 to output audio through the second channel. In at least some embodiments, application manager 220 transmits the association instruction in response to determining that the head unit has sufficient resources for simultaneous audio output.

At S239, application manager 220 transmits an activation instruction to second application 224. In at least some embodiments, application manager 220 instructs second application 224 to activate audio transmission. In at least some embodiments, second application 224 processes the activation instruction to start transmitting audio. In at least some embodiments, the activation instruction is a signal or data packet. In at least some embodiments, the activation instruction is transmitted to cause second application 224 to start the audio output. In at least some embodiments, application manager 220 transmits the activation instruction in response to associating the second channel with second application 224.

In at least some embodiments, at least some of the transmissions by application manager 220 are performed by an arbitration manager.

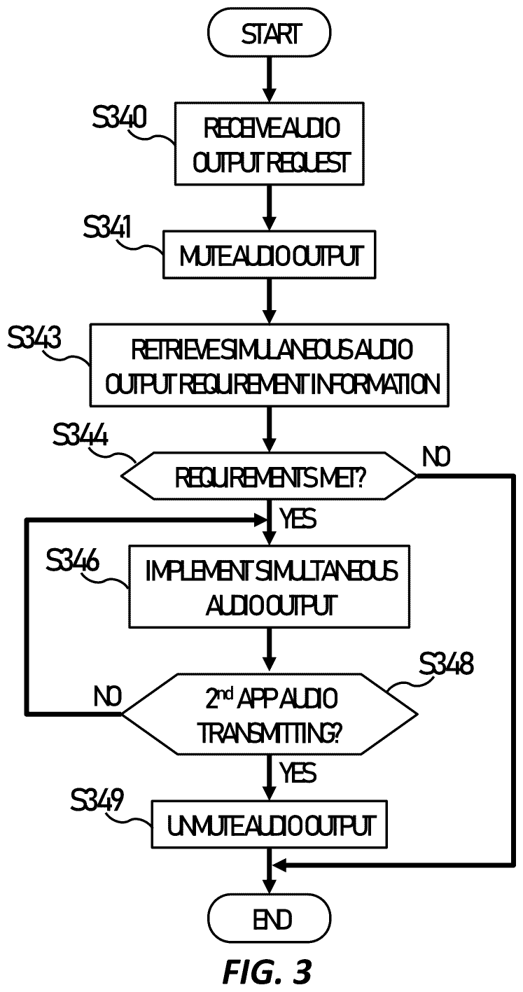

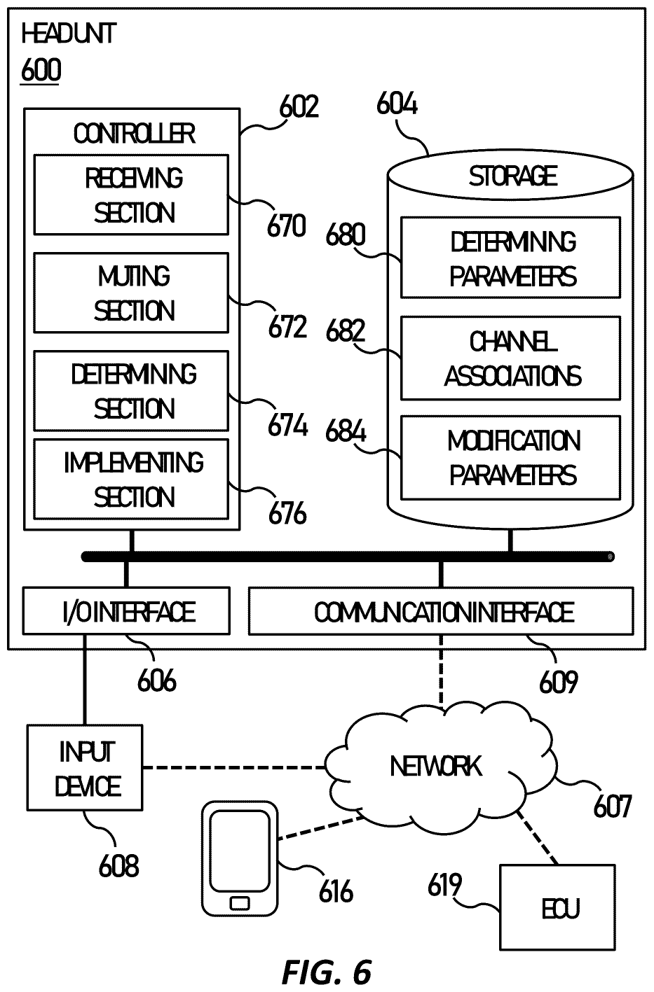

FIG. 3 is an operational flow for simultaneous audio output resulting from priority arbitration, according to at least some embodiments of the subject disclosure. The operational flow provides a method of simultaneous audio output resulting from priority arbitration. In at least some embodiments, the method is performed by a controller of a head unit, such as controller 102 of head unit 100 of FIG. 1, or controller 602 of head unit 600 of FIG. 6.

At S340, a receiving section of the controller receives an audio output request. In at least some embodiments, the receiving section receives, while a front speaker and a rear speaker in communication with an amplifier output audio from a first application, a request to output audio from a second application. In at least some embodiments, the receiving section receives the audio output request in response to a user action. In at least some embodiments, the receiving section receives the audio output request from an arbitration manager. In at least some embodiments, the receiving section receives the audio output request from an ECU through a CAN. In at least some embodiments, the audio output request identifies the second application. In at least some embodiments, the operational flow is triggered when the receiving section receives the audio output request from the second application while one or more speakers output audio from the first application.

At S341, a muting section of the controller mutes the audio output. In at least some embodiments, the muting section mutes audio output in response to receiving the audio output request. In at least some embodiments, the muting section causes the audio output to be muted. In at least some embodiments, the muting section mutes the audio output to prevent interference with the audio output from the first application. In at least some embodiments, the muting section suppresses audio transmission from the first application. In at least some embodiments, the muting section suppresses audio transmission to the amplifier. In at least some embodiments, the muting section instructs the amplifier to set a speaker volume to zero. In at least some embodiments, muting audio output includes at least one of suppressing audio transmission from the first application, suppressing audio transmission to the amplifier, or instructing the amplifier to set a speaker volume to zero.

At S343, a determining section of the controller retrieves simultaneous audio output requirement information. In at least some embodiments, the determining section retrieves information representing a resource requirement for each application. In at least some embodiments, the determining section causes the first application and the second application to each provide resource requirement information. In at least some embodiments, the determining section retrieves the simultaneous audio output requirement information to determine whether the requirements for simultaneous audio output are met.

At S344, the determining section determines whether the requirements are met. In at least some embodiments, the determining section determines whether a head unit and an amplifier have sufficient resources to meet the resource requirement of each application for simultaneous audio output. In at least some embodiments, the determining section determines whether the requirements are met to ensure that the head unit and the amplifier have sufficient computational resources to timely process audio signals for each application. If the determining section determines that the requirements are met, then the operational flow proceeds to simultaneous audio output implementation at S346. If the determining section determines that the requirements are not met, then the operational flow ends.

At S346, an implementing section of the controller implements simultaneous audio output. In at least some embodiments, the implementing section instructs the amplifier to modify a speaker input of a channel and associate the speaker input with another channel. In at least some embodiments, the implementing section activates audio transmission. In at least some embodiments, the implementing section implements simultaneous audio output to allow the first and second applications to output audio simultaneously. In at least some embodiments, the implementing section implements simultaneous audio output in response to the determining section determining that the requirements are met.

At S348, the implementing section determines whether the second application is transmitting audio. In at least some embodiments, the implementing section determines whether the second application is transmitting audio to verify that an audio activation instruction was successfully received by the second application. In at least some embodiments, the implementing section determines whether the second application is transmitting audio in response to instructing the second application to activate audio transmission. If the implementing section determines that the second application is transmitting audio, then the operational flow proceeds to unmuting at S349. If the implementing section determines that the second application is not transmitting audio, then the operational flow returns to simultaneous audio output implementation at S346.

At S349, the muting section unmutes the audio output. In at least some embodiments, the muting section unmutes the audio output in response to determining that the second application is transmitting audio data. In at least some embodiments, the muting section unmutes the audio output to allow the audio from the second application to be heard. In at least some embodiments, the muting section causes the audio output to be unmuted. In at least some embodiments, the muting section unmutes the audio output to complete the process of implementing simultaneous audio output. In at least some embodiments, the muting section unmutes the audio output in response to the implementing section determining that the second application is transmitting audio data.

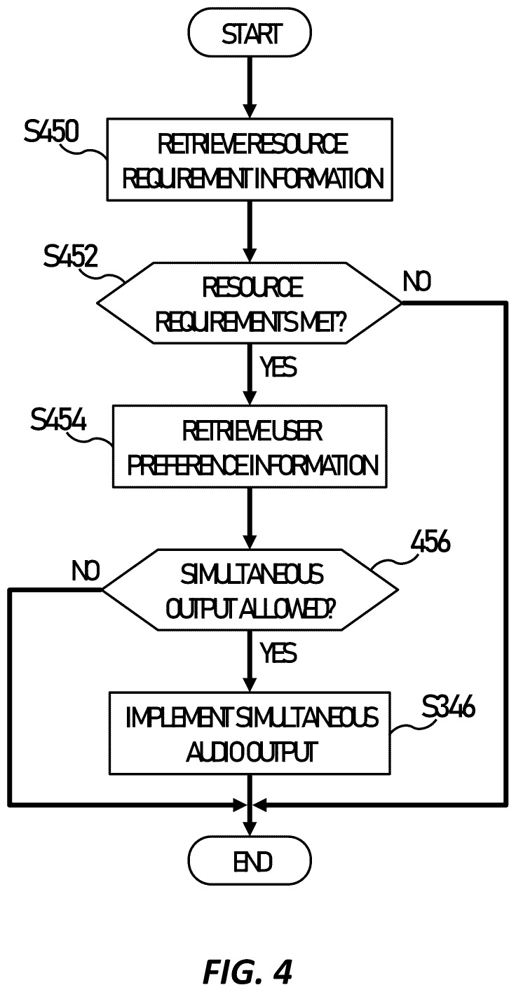

FIG. 4 is an operational flow for retrieving simultaneous audio output requirement information and determining whether the requirements are met, according to at least some embodiments of the subject disclosure. The operational flow provides a method of retrieving simultaneous audio output requirement information, such as the operation at S343 of FIG. 3, and determining whether the requirements are met, such as the operation at S344 of FIG. 3. In at least some embodiments, the method is performed by a determining section of a controller in a head unit, such as controller 102 of head unit 100 of FIG. 1, or controller 602 of head unit 600 of FIG. 6.

At S450, the determining section retrieves resource requirement information. In at least some embodiments, the determining section retrieves, for each of the first application and the second application, information representing a resource requirement. In at least some embodiments, the determining section retrieves the resource requirement information to determine whether the head unit and an amplifier have sufficient resources to meet the resource requirement of each application for simultaneous audio output. In at least some embodiments, the determining section retrieves the resource requirement information in response to receiving a request to output audio from a second application. In at least some embodiments, the resource requirement includes an interface resource requirement and a decoding resource requirement. In at least some embodiments, the decoding resource requirement includes a hardware decoder requirement. In at least some embodiments, the interface resource requirement includes a touchscreen requirement. In at least some embodiments, the interface resource requirement includes a front speaker requirement. In at least some embodiments, the resource requirement includes one of a privacy requirement or a security requirement.

At S452, the determining section determines whether there are sufficient resources. In at least some embodiments, the determining section determines whether a head unit and an amplifier have sufficient resources to meet the resource requirement of each application for simultaneous audio output. If the determining section determines that there are sufficient resources, then the operational flow proceeds to user preference information retrieval at S454. If the determining section determines that there are not sufficient resources, then the operational flow ends.

At S454, the determining section retrieves user preference information. In at least some embodiments, the determining section retrieves user preference information to determine whether the user preference information prohibits simultaneous audio output. In at least some embodiments, the determining section retrieves the user preference information in response to determining that there are sufficient resources.

At S456, the determining section determines whether simultaneous output is allowed. In at least some embodiments, the determining section determines whether the user preference information prohibits simultaneous audio output. In response to the determining section determining that simultaneous output is allowed, the operational flow proceeds to simultaneous audio output implementation, such as the operation at S346 of FIG. 3. In response to the determining section determining that simultaneous output is not allowed, the operational flow ends.

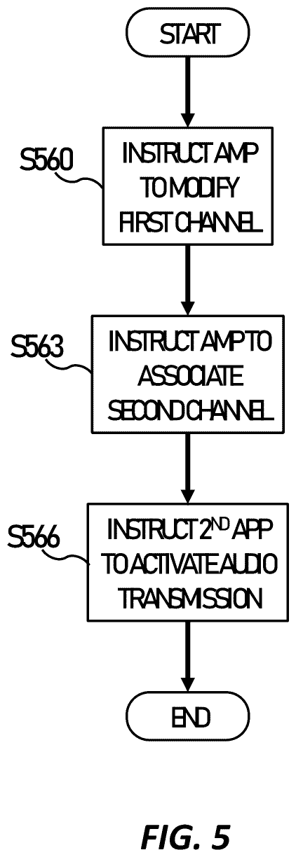

FIG. 5 is an operational flow for implementing simultaneous audio output, according to at least some embodiments of the subject disclosure. The operational flow provides a method of implementing simultaneous audio output, such as the operation at S346 of FIG. 3. In at least some embodiments, the method is performed by an implementing section of a controller in a head unit, such as controller 102 of head unit 100 of FIG. 1, or controller 602 of head unit 600 of FIG. 6.

At S560, the implementing section instructs the amplifier to modify a first channel. In at least some embodiments, the implementing section instructs the amplifier to modify the first channel to remove one of a front speaker input or a rear speaker input. In at least some embodiments, the implementing section instructs, in response to determining that the head unit and the amplifier have sufficient resources for simultaneous audio output, the amplifier to modify a first channel to remove one of a front speaker input or a rear speaker input. In at least some embodiments, the implementing section causes the amplifier to modify the first channel accordingly. In at least some embodiments, the implementing section instructs the amplifier to modify the first channel in response to determining that the system has sufficient resources for simultaneous audio output.

At S563, the implementing section instructs the amplifier to associate the second channel. In at least some embodiments, the implementing section instructs the amplifier to associate a second channel with the second application for output to the one of the front speaker input or the rear speaker input that was removed from the first channel. In at least some embodiments, the implementing section causes the amplifier to associate the second channel with the second application. In at least some embodiments, the implementing section causes the second channel to be associated with the second application to enable the second application to output audio through the second channel. In at least some embodiments, the implementing section instructs the amplifier to associate the second channel in response to the amplifier modifying the first channel. In at least some embodiments, the second channel has at least one of an audio bitrate, sampling rate, buffer size, or equalizer setting corresponding to the second application as a result of the instruction.

At S566, the implementing section instructs the second application to activate audio transmission. In at least some embodiments, the implementing section causes the second application to start transmitting audio. In at least some embodiments, the implementing section causes the audio output from the second application to be activated to output audio simultaneously with the first application. In at least some embodiments, the implementing section instructs the second application to activate audio transmission in response to the amplifier associating the second channel with the second application.

FIG. 6 is a block diagram of a hardware configuration for simultaneous audio output resulting from priority arbitration, according to at least some embodiments of the present invention.

The exemplary hardware configuration includes head unit 600, which interacts with input device 608 directly or through network 607 and interacts with ECU 619 and smartphone 616 through network 607. In at least some embodiments, network 607 is an ethernet network, a CAN, or any other wired or wireless network or a combination thereof. In at least some embodiments, head unit 600 is a computer or other computing device that receives input or commands from input device 608. In at least some embodiments, head unit 600 is integrated with input device 608. In at least some embodiments, head unit 600 is a computer system that executes computer-readable instructions to perform operations for simultaneous audio output resulting from priority arbitration.

Head unit 600 includes a controller 602, a storage unit 604, an input/output interface 606, and a communication interface 609. In at least some embodiments, controller 602 includes a processor or programmable circuitry executing instructions to cause the processor or programmable circuitry to perform operations according to the instructions. In at least some embodiments, controller 602 includes analog or digital programmable circuitry, or any combination thereof. In at least some embodiments, controller 602 includes physically separated storage or circuitry that interacts through communication. In at least some embodiments, storage unit 604 includes a non-volatile computer-readable medium capable of storing executable and non-executable data for access by controller 602 during execution of the instructions. Communication interface 609 transmits and receives data from network 607. Input/output interface 606 connects to various input and output units, such as input device 608, via a parallel port, a serial port, a keyboard port, a mouse port, a monitor port, and the like to accept commands and present information. In some embodiments, storage unit 604 is external from head unit 600.

Controller 602 includes receiving section 670, muting section 672, determining section 674, and implementing section 676. Storage unit 604 includes determining parameters 680, channel associations 682, and modification parameters 684.

Receiving section 670 is the circuitry or instructions of controller 602 configured to receive audio output requests. In at least some embodiments, receiving section 670 is configured to receive, while a front speaker and a rear speaker in communication with an amplifier output audio from a first application, a request to output audio from a second application. In at least some embodiments, receiving section 670 utilizes information in storage unit 604, such as channel associations 682. In at least some embodiments, receiving section 670 includes sub-sections for performing additional functions, as described in the foregoing flow charts. In at least some embodiments, such sub-sections are referred to by a name associated with a corresponding function.

Muting section 672 is the circuitry or instructions of controller 602 configured to mute and unmute audio output. In at least some embodiments, muting section 672 is configured to mute audio output in response to receiving the request, and to unmute the audio output in response to determining that the second application is transmitting audio data. In at least some embodiments, muting section 672 utilizes information in storage unit 604, such as channel associations 682 and modification parameters 684. In at least some embodiments, muting section 672 includes sub-sections for performing additional functions, as described in the foregoing flow charts. In at least some embodiments, such sub-sections are referred to by a name associated with a corresponding function.

Determining section 674 is the circuitry or instructions of controller 602 configured to determine whether simultaneous audio output requirements are met. In at least some embodiments, determining section 674 is configured to determine whether a head unit and an amplifier have sufficient resources to meet the resource requirement of each application for simultaneous audio output. In at least some embodiments, muting section 672 utilizes information in storage unit 604, such as modification parameters 684. In at least some embodiments, determining section 674 includes sub-sections for performing additional functions, as described in the foregoing flow charts. In at least some embodiments, such sub-sections are referred to by a name associated with a corresponding function.

Implementing section 676 is the circuitry or instructions of controller 602 configured to implement simultaneous audio output. In at least some embodiments, implementing section 676 is configured to instruct, in response to determining that the head unit and the amplifier have sufficient resources for simultaneous audio output, the amplifier to modify a first channel to remove one of a front speaker input or a rear speaker input, to instruct the amplifier to associate a second channel with the second application for output to the one of the front speaker input or the rear speaker input that was removed from the first channel, and to instruct the second application to activate audio transmission. In at least some embodiments, implementing section 676 utilizes information in storage unit 604, such as determining parameters 680. In at least some embodiments, determining section 674 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, simultaneous audio output resulting from priority arbitration is performed by receiving, while a front speaker and a rear speaker in communication with an amplifier output audio from a first application, a request to output audio from a second application, retrieving, for each of the first application and the second application, information representing a resource requirement, determining whether a head unit and an amplifier have sufficient resources to meet the resource requirement of each application for simultaneous audio output, instructing, in response to determining that the head unit and the amplifier have sufficient resources for simultaneous audio output, the amplifier to modify a first channel to remove one of a front speaker input or a rear speaker input, instructing the amplifier to associate a second channel with the second application for output to the one of the front speaker input or the rear speaker input that was removed from the first channel, and instructing the second application to activate audio transmission. In at least some embodiments, the resource requirement includes an interface resource requirement and a decoding resource requirement. In at least some embodiments, the decoding resource requirement includes a hardware decoder requirement. In at least some embodiments, the interface resource requirement includes a touchscreen requirement. In at least some embodiments, the interface resource requirement includes a front speaker requirement. In at least some embodiments, the resource requirement includes one of a privacy requirement or a security requirement. In at least some embodiments, simultaneous audio output resulting from priority arbitration is further performed by retrieving user preference information, and determining whether the user preference information prohibits simultaneous audio output. In at least some embodiments, simultaneous audio output resulting from priority arbitration is further performed by muting audio output in response to receiving the request, and unmuting the audio output in response to determining that the second application is transmitting audio data. In at least some embodiments, the second channel has at least one of an audio bitrate, sampling rate, buffer size, or equalizer setting corresponding to the second application.

In at least some embodiments, simultaneous audio output resulting from priority arbitration is performed by a processor executing instructions in accordance with the foregoing operations or a device comprising a controller including circuitry configured to perform the foregoing operations.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium storing instructions that, when executed by one or more processors, cause the one or more processors to performs operations comprising:
receiving, while a front speaker and a rear speaker that are in communication with an amplifier output audio from a first application, a request to output audio from a second application;
retrieving, for each of the first application and the second application, information representing a resource requirement;
determining whether a head unit and an amplifier have sufficient resources to meet the resource requirement of each application for simultaneous audio output;
instructing, in response to determining that the head unit and the amplifier have sufficient resources for simultaneous audio output, the amplifier to modify a first channel to remove one of a front speaker input or a rear speaker input;
instructing the amplifier to associate a second channel with the second application for output to the one of the front speaker input or the rear speaker input that was removed from the first channel; and
instructing the second application to activate audio transmission.

2. The computer-readable medium of claim 1, wherein the resource requirement includes an interface resource requirement and a decoding resource requirement.

3. The computer-readable medium of claim 2, wherein the decoding resource requirement includes a hardware decoder requirement.

4. The computer-readable medium of claim 2, wherein the interface resource requirement includes a touchscreen requirement.

5. The computer-readable medium of claim 2, wherein the interface resource requirement includes a front speaker requirement.

6. The computer-readable medium of claim 1, wherein the resource requirement includes one of a privacy requirement or a security requirement.

7. The computer-readable medium of claim 1, wherein the operations further comprise:
retrieving user preference information; and
determining whether the user preference information prohibits simultaneous audio output.

8. The computer-readable medium of claim 1, wherein the operations further comprise:
muting audio output in response to receiving the request; and
unmuting the audio output in response to determining that the second application is transmitting audio data.

9. The computer-readable medium of claim 1, wherein the second channel has at least one of an audio bitrate, a sampling rate, a buffer size, or an equalizer setting corresponding to the second application.

10. A method comprising:
receiving, while a front speaker and a rear speaker that are in communication with an amplifier output audio from a first application, a request to output audio from a second application;
retrieving, for each of the first application and the second application, information representing a resource requirement;
determining whether a head unit and an amplifier have sufficient resources to meet the resource requirement of each application for simultaneous audio output;
instructing, in response to determining that the head unit and the amplifier have sufficient resources for simultaneous audio output, the amplifier to modify a first channel to remove one of a front speaker input or a rear speaker input;
instructing the amplifier to associate a second channel with the second application for output to the one of the front speaker input or the rear speaker input that was removed from the first channel; and
instructing the second application to activate audio transmission.

11. The method of claim 10, wherein the resource requirement includes an interface resource requirement and a decoding resource requirement.

12. The method of claim 11, wherein the decoding resource requirement includes a hardware decoder requirement.

13. The method of claim 11, wherein the interface resource requirement includes a touchscreen requirement.

14. The method of claim 11, wherein the interface resource requirement includes a front speaker requirement.

15. The method of claim 10, wherein the resource requirement includes one of a privacy requirement or a security requirement.

16. The method of claim 10, further comprising:
retrieving user preference information; and
determining whether the user preference information prohibits simultaneous audio output.

17. The method of claim 10, further comprising:
muting audio output in response to receiving the request; and
unmuting the audio output in response to determining that the second application is transmitting audio data.

18. The method of claim 10, wherein the second channel has at least one of an audio bitrate, a sampling rate, a buffer size, or an equalizer setting corresponding to the second application.

19. A device comprising:
a controller including circuitry configured to perform operations including:
receiving, while a front speaker and a rear speaker that are in communication with an amplifier output audio from a first application, a request to output audio from a second application,
retrieving, for each of the first application and the second application, information representing a resource requirement,
determining whether a head unit and an amplifier have sufficient resources to meet the resource requirement of each application for simultaneous audio output,
instructing, in response to determining that the head unit and the amplifier have sufficient resources for simultaneous audio output, the amplifier to modify a first channel to remove one of a front speaker input or a rear speaker input,
instructing the amplifier to associate a second channel with the second application for output to the one of the front speaker input or the rear speaker input that was removed from the first channel, and
instructing the second application to activate audio transmission.

20. The device of claim 19, wherein the resource requirement includes an interface resource requirement and a decoding resource requirement.
